(19) United States
(12) Patent Application Publication
(10) Pub. No.: US 2019/0102811 A1
(43) Pub. Date: Apr. 4, 2019

(54) FLEXIBLE CROSS-COMPONENT CONFIGURATIONS IN CPQ PLATFORMS

(71) Applicant: Oracle International Corporation, Redwood Shores, CA (US)

(72) Inventors: Fazal Gupta, Hayward, CA (US); Frank Joseph Carlesimo, III, Evanston, IL (US); Kevin Joseph Siamis, Springs, IL (US); Richard Leigh Jones, Gurnee, IL (US); Myrland Joseph Gray, Lombard, IL (US); Jacob Edward Winter, Waukegan, IL (US)

(73) Assignee: Oracle International Corporation, Redwood Shores, CA (US)

(21) Appl. No.: 15/996,086

(22) Filed: Jun. 1, 2018

Related U.S. Application Data
(60) Provisional application No. 62/566,283, filed on Sep. 29, 2017.

(51) Int. Cl. G06Q 30/02; G06Q 30/06

(52) U.S. Cl. CPC G06Q 30/0283; G06Q 30/0621; G06Q 30/0611

(57) ABSTRACT

Techniques for operating a configure, price, quote (CPQ) platform are provided. The techniques include obtaining a set of component configurations for a set of components in the CPQ platform and a system definition for a system in the CPQ platform. The component configurations include a set of component attributes for the components and a first set of attribute values for the component attributes. The system definition includes a system attribute of the system, the components, and a set of rules to be applied to the component attributes and the system attribute. Next, the rules are applied to the first set of attribute values to produce a second set of attribute values for the system attribute and the component attributes. A system configuration for the system is then outputted, wherein the first system configuration includes the second set of attribute values.

### BENEFIT CLAIMS; RELATED APPLICATIONS; INCORPORATION BY REFERENCE

This application claims the benefit of U.S. Provisional Patent Application 62/566,283, filed Sep. 29, 2017, which is hereby incorporated by reference.

### TECHNICAL FIELD

The present disclosure relates to configure, price, quote (CPQ) platforms. In particular, the present disclosure relates to techniques for performing system-based configuration of components in CPQ platforms.

### BACKGROUND

Configure, price, quote (CPQ) platforms are commonly used to generate quotes and manage the configuration of products and services offered by companies. For example, a company may use a CPQ platform to track the supply of products; specify or select options associated with the products; apply requirements, constraints, or customizations to the products, product prices, or customers of the products; or generate and transmit proposals and quotes for the configured products. In turn, the flexible configuration, tracking, customization, and pricing of complex products through CPQ platforms may streamline and simplify the sales processes of the companies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example cross-component configuration in a configure, price, quote (CPQ) platform in accordance with one or more embodiments;

FIG. 3 illustrates a flowchart of operating a CPQ platform in accordance with one or more embodiments;

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. EXAMPLE EMBODIMENT

4. FLEXIBLE CROSS-COMPONENT CONFIGURATIONS IN CPQ PLATFORMS

5. COMPUTER NETWORKS AND CLOUD NETWORKS

6. MISCELLANEOUS; EXTENSIONS

7. HARDWARE OVERVIEW

1. General Overview

A Configure, Price, Quote (CPQ) platform may be used to configure complex products for pricing or selling of the products. The CPQ platform selects or obtains a system definition representing the product to be priced or sold. The system definition includes configurations for the system, components in the system, and attributes of the components or system.

Some embodiments further define a system definition to include a set of rules to be applied to the configurations defined in the system definition. The CPQ platform applies the rules to the system definition or component configurations to enforce inter-dependencies among the components or attributes configured for a product. For example, the CPQ platform may apply a rule to update or verify a system attribute based on component attribute(s). The CPQ platform may also, or instead, apply a rule to a value for an attribute of a component to determine a value for an attribute of another, different component. After the system and component configurations are updated based on the rules, the CPQ platform presents the system definition to allow a user to adjust attribute values in the component and system definitions. The CPQ platform implements a reiterative adjustment process, responsive to user input, until all attribute values conform to the rules. Since the rules allow attributes of the components or the product to be defined and configured with respect to one another, the CPQ platform increases flexibility and reduces overhead associated with configuring the product.

This Specification may describe, and/or the claims may recite, embodiments beyond those that are specifically included in this General Overview section.

2. Architectural Overview

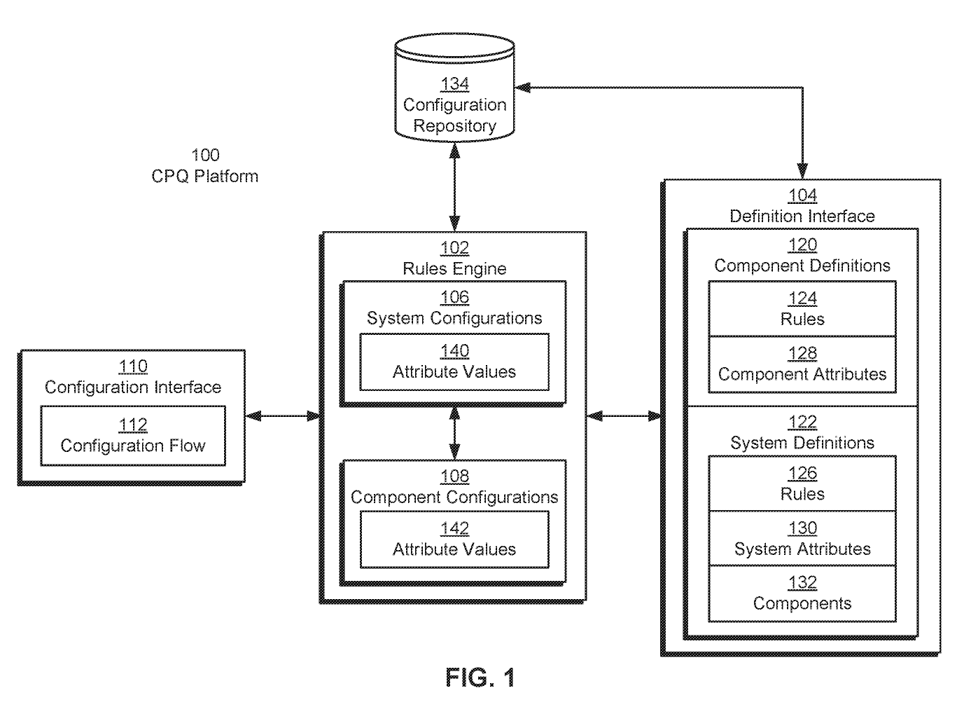

FIG. 1 illustrates a system in accordance with one or more embodiments. As illustrated in FIG. 1, the system may be a configure, price, quote (CPQ) platform 100 that performs flexible configuration, pricing, and quoting of products or services offered for sale by companies or other entities. For example, CPQ platform 100 may be used to combine configurations for multiple products, pricing structures for the products, and customer needs into one or more customized quotes that are delivered to the customers or approved by the customers through CPQ platform 100.

CPQ platform 100 may include a definition interface 104 that allows one or more users to define parameters for facilitating subsequent configuration of products or services through CPQ platform 100. Definition interface 104 may include a graphical user interface (GUI), web-based user interface, command line interface, voice user interface, or other type of interface that accepts input from users and generates output based on the input.

In particular, definition interface 104 may obtain component definitions 120 of a set of components, as well as system definitions 122 of one or more systems made up of multiple components or one or more other systems. For example, the components may include processors, disk drives, memory, network cards, peripheral devices, input/output (I/O) devices, power supplies, batteries, operating systems, applications, device drivers, or other hardware or software components. Systems composed of the components may include servers, personal computers, laptop computers, workstations, portable electronic devices, gaming consoles, or other types of electronic devices. The electronic devices may then be aggregated into larger systems such as server racks, clusters, grids, data centers, cloud computing systems, or other collections of computer systems.

More specifically, each of component definitions 120 may include a set of component attributes 128, along with a set of rules 124 to be applied to component attributes 128. For example, component attributes 128 associated with a disk drive may include a disk drive type (e.g., hard disk drive (HDD), solid-state drive (SSD), optical drive, etc.), manufacturer, model, storage capacity, power consumption, read speed, write speed, interface, input/output operations per second (IOPS), or other parameters related to data storage devices in electronic devices. Rules 124 to be applied to the disk drive may include constraints such as hardcoded values, ranges of values, or sets of allowed values for component attributes 128 (e.g., disk drive types, storage capacities, power consumption, performance metrics, etc.). Rules 124 may also specify conditions to be applied to component attributes 128, such as formulas or functions for calculating attribute values 142 of component attributes 128 based on other attributes values or rules 124 (e.g., calculating power consumption or performance metrics based on other selected disk drive attributes). Rules 124 may additionally be used to specify a configuration flow 112 for use in subsequent configuration of component attributes 128 (e.g., a series of steps or screens displayed within a configuration interface 104 for specifying values of component attributes 128 for the disk drive). One or more rules 124 may also, or instead, be used to hide component attributes 128 in configuration flow 112 (e.g., to prevent configuration of the attributes within configuration flow 112). Finally, rules 124 may be used to set a price of the disk drive based on component attributes 128 or recommend certain component attributes 128 (e.g., upselling to SSDs instead of HDDs for performance reasons, etc.).

Alternatively, one or more components may include non-configurable component definitions 120 with pre-set component attributes 128 and attribute values 142. For example, a component representing a central-processing unit (CPU) in a computer system may include non-configurable attributes such as manufacturer, model, architecture, clock speed, number of cores, registers, cache size, integrated graphics-processing unit (GPU), bit width, heat dissipation, or power consumption. As a result, definition interface 104 or another component of CPQ platform 100 may obtain a set of available CPUs and the corresponding attributes and provide the available CPUs as options for configuring a CPU attribute of a component or system representing a computer system.

Each of system definitions 122 may include a set of components 132, a set of system attributes 130, and a set of rules 126 to be applied to system attributes 130. For example, a system definition for a computer system may identify components 132 such as one or more disk drives, processors, memory modules, interfaces, network cards, power supplies, batteries, operating systems, applications, I/O devices, or other hardware or software components. System attributes 130 for the computer system may include dimensions, weight, power consumption, computer type (e.g., laptop, desktop, etc.), screen size, material, or color. In turn, rules 126 may include constraints on weight or power consumption, formulas or functions for calculating or limiting power consumption or weight based on component attributes 128 of components 132, or determining the price of the computer system based on the selected components 132 or component attributes 128.

Rules 126 may additionally be applied to component attributes 128 of components 132 in a system definition based on other component attributes 128 or system attributes 130 in the system definition. Continuing with the previous example, rules 126 may enforce the selection of a particular type of power supply or a power supply with a certain power output based on the power drawn by other components of the computer system. Similarly, rules 126 may require applications in the computer system to be compatible with the operating system selected for the computer system.

In another example, a system definition for a rack may include a set of components 132 representing servers, switches, audio and video equipment, or other rack-mountable electronic equipment. The system definition may include system attributes 130 such as dimensions, number of rack units, weight limit, color, material, cooling capabilities, maximum power consumption, rack style (e.g., open frame, cabinet, etc.) or number of posts. Rules 126 may ensure that components 132 in the rack adhere to the number of rack units, weight limit, cooling capabilities, or maximum power consumption. Rules 126 may also ensure that switches in the rack have sufficient numbers of ports to connect to other servers or other components in the rack. In other words, a system in CPQ platform 100 may represent a “container” for a set of components (e.g., components 132) or other containers. In turn, a system definition for the system may identify the components within the container and specify dependencies or other constraints among the components or between the components and the system to ensure that the components function together to solve a different or larger need.

Definition interface 104 or another component of the system may store component definitions 120 and system definitions 122 in a configuration repository 134 for subsequent retrieval and use. For example, the component may store rules 124-126, component attributes 128, system attributes 130, components 132, or other parts of component definitions 120 and system definitions 122 in a database, data warehouse, cloud storage, or other data-storage mechanism providing configuration repository 134.

After component definitions 120 for a set of components 132 and system definitions 122 for one or more systems containing components 132 or other systems are created, CPQ platform 100 may use component definitions 120 to generate a set of component configurations 108 containing attribute values 140 for the corresponding component attributes 128. CPQ platform 100 may then use attribute values 140 and system definitions 122 to generate one or more system configurations 106 containing attribute values 142 for the corresponding system attributes 130 or updated attribute values 140 for component attributes 128. In turn, component attributes 128, system attributes 130, and the corresponding attribute values 140-142 may describe a functional arrangement of components in a system that meets customer needs and can be priced and used to produce a quote.

As shown in FIG. 1, CPQ platform 100 may provide a configuration interface 110 that is used by other sales representatives or other users to configure components 132 or systems containing the components for customers. Within configuration interface 110, the users may interact with a configuration flow 112 specified in one or more rules 124-126 for the corresponding components or systems to produce component configurations 108 and system configurations 106.

First, configuration interface 110 may obtain a portion of attribute values 140-142 from a user. For example, configuration interface 110 may display drop-down menus, sliders, text boxes, checkboxes, radio buttons, or other user-interface elements for selecting or specifying attribute values 140-142. The user-interface elements may be configured to include ranges or sets of possible attribute values 140-142 that are specified in rules 124-126 from the corresponding component definitions 120 or system definitions 122. In turn, the user may interact with the user-interface elements to specify attribute values 140-142 for a system or components 132 in a system.

Next, a rules engine 102 in CPQ platform 100 may use rules 124-126 to validate attribute values 140-142 received through configuration interface 110 or generate additional attribute values 140-142 required to complete component configurations 108 or system configurations 106. In particular, rules engine 102 may combine attribute values 140-142 obtained from configuration interface 110 with default or pre-specified attribute values 140-142 from rules 124-126. Rules engine 102 may apply additional rules 124-126 that enforce dependencies or constraints across attribute values 140-142 from different components in the system or calculate additional attribute values 140-142 from other attribute values 140-142 in the system. As a result, rules engine 102 may use a constraint-solving, local search, optimization, backtracking, or other technique for solving constraint satisfaction problems to generate component configurations 108 or system configurations 106 based on rules 124-126.

For example, rules engine 102 may ensure that attribute values 142 for configuring component attributes 128 for components 132 of a computer system result in system attributes 130 that are within the maximum power consumption, weight limit, or size limit of the computer system, as well as the maximum price a customer is willing to pay for the computer system. In another example, rules engine 102 may ensure that attribute values for a battery or a power supply in an electronic device result in a battery runtime or power output that meets the customer's requirements and can accommodate the power consumption of other components in the electronic device. In a third example, rules engine 102 may verify that a set of rack-mounted components fit within the height of a server rack or select the height of the server rack to accommodate the components. In a fourth example, rules engine 102 may select attribute values for configuring hardware components (e.g., processor, memory, storage, etc.) in a computer system based on other attribute values for configuring software components (e.g., operating system, applications, etc.) in the computer system, thus ensuring that the hardware components are compatible with and meet requirements or recommendations associated with the software components.

If a given attribute value of a component or system configuration violates one or more rules 124-126, configuration interface 110 may display a message or notification of the violation and request correction of the violation. In turn, the user may iteratively adjust the attribute value or other attribute values in the component or system configuration until all attribute values 140-142 in the component or system configuration conform to the corresponding rules 124-126.

For example, the user may use configuration interface 110 to specify or adjust one or more attribute values 140-142 in one or more component configurations 108. Rules engine 102 may validate the received attribute values or use the attribute values to update other attribute values in other component configurations 108 or one or more system configurations 106 containing the component configurations. When an attribute received from the user or generated by rules engine 102 violates one or more rules 124-126, configuration interface 110 may notify the user of the violation, and the user may update one or more attribute values associated with the violation to correct the violation. The user may also, or instead, iteratively adjust attribute values 142 in one or more component configurations 108 to achieve desired attribute values 140-142 for other component configurations 108 and system configurations 106. Consequently, component configurations 108 or system configurations 106 may be finalized after multiple rounds (e.g., tens to hundreds) of iteration between the user and rules engine 102.

After rules engine 102 has generated or verified attribute values 140-142 for final versions of system configurations 106 and component configurations 108, CPQ platform 100 may generate prices or quotes for system configurations 106 and component configurations 108. CPQ platform 100 may also submit one or more portions of system configurations 106 or component configurations 108 for approval by customers or entities involved in selling the corresponding systems or components to the customers.

By allowing rules 124-126 to be defined and applied across components 132 of a system or a hierarchy of systems contained within other systems, CPQ platform 100 may enable the definition and configuration of complex products with multiple layers of interdependent components. Consequently, the system of FIG. 1 may improve the use of computer systems and CPQ technologies executing on the computer systems by increasing the flexibility and functionality of the CPQ technologies.

In one or more embodiments, the system may include more or fewer components than the components illustrated in FIG. 1. For example, rules engine 102, definition interface 104, configuration interface 110, or configuration repository 134 may include, execute with, or exclude one another. In another example, CPQ platform 100 may include additional components for generating prices, proposals, or quotes from system configurations 106 or component configurations 108. Such components may be local to or remote from each other, implemented in software or hardware, or distributed over multiple applications or machines. Multiple components may also be combined into one application or machine. Operations described with respect to one component may instead be performed by another component.

Additional embodiments and/or examples relating to computer networks are described below in Section 6, titled “Computer Networks and Cloud Networks.”

In one or more embodiments, a data repository (e.g., configuration repository 134) is any type of physical or virtual storage unit or device (e.g., a filesystem, database, collection of tables, or any other storage mechanism) for storing data. Further, the data repository may include multiple different storage units or devices. The multiple different storage units or devices may or may not be of the same type or located at the same physical site. The data repository may be implemented or may execute on the same computing system as rules engine 102, definition interface 104, or configuration interface 110 or on a computing system that is separate from rules engine 102, definition interface 104, or configuration interface 110. The data repository may be communicatively coupled to rules engine 102, definition interface 104, or configuration interface 110 via a direct connection or via a network.

In one or more embodiments, CPQ platform 100 refers to hardware or software configured to perform configuring, pricing, and quoting of components or systems of components. Examples of such operations are described below.

In an embodiment, CPQ platform 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, or a client device.

3. Example Embodiment

A detailed example is described below for purposes of clarity. Components or operations described below should be understood as one specific example, which may not be applicable to certain embodiments. Accordingly, components or operations described below should not be construed as limiting the scope of any of the claims.

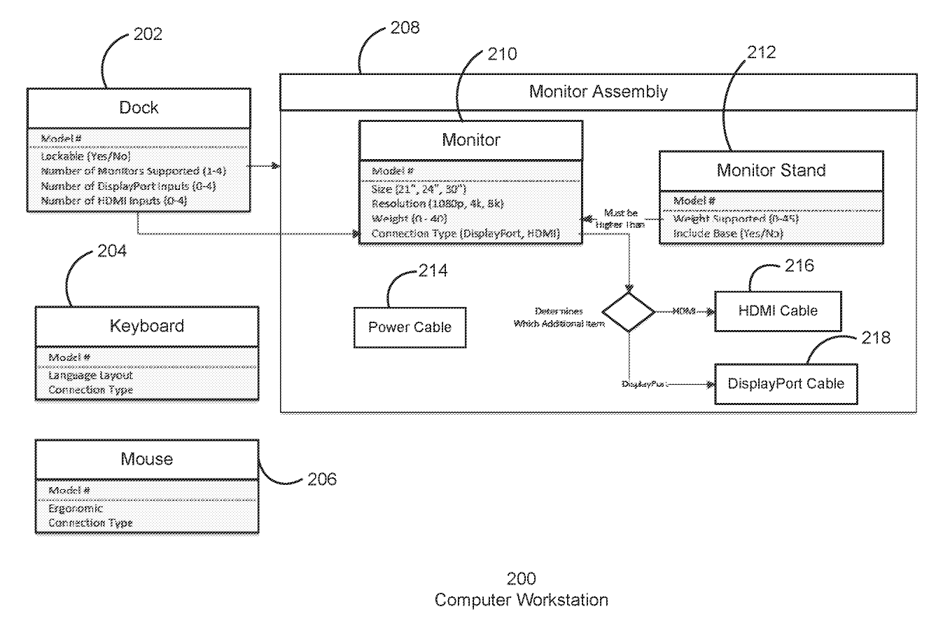

The operation of CPQ platform 100 may be illustrated using the example cross-component configuration of FIG. 2. More specifically, FIG. 2 shows a cross-component configuration of a system representing a computer workstation 200. A system definition for computer workstation 200 includes components such as a dock 202, a keyboard 204, and a mouse 206. The system definition also includes, within computer workstation 200, an additional system representing a monitor assembly 208. The system definition for monitor assembly 208 includes components such as a monitor 210, a monitor stand 212, a power cable 214, a High-Definition Multimedia Interface (HDMI) (HDMI™ is a registered trademark of HDMI Licensing L.L.C) cable 216, or a DisplayPort cable 218.

In other words, the system representing computer workstation 200 may function as a container for components representing dock 202, keyboard 204, and mouse, as well as another system representing monitor assembly 208. In turn, the system representing monitor assembly 208 may function as a container for components representing monitor 210, monitor stand 212, power cable 214, HDMI cable 216, or DisplayPort cable 218.

Each component in computer workstation 200 or monitor assembly 208 is represented by a component definition that includes component attributes of the component, as well as rules to be applied to the component attributes. Dock 202 includes component attributes such as a model number, a “lockable” attribute (e.g., indicating if dock 202 can be locked or not), a number of monitors supported, a number of DisplayPort inputs, and a number of HDMI inputs. Rules associated with the component attributes may include a limit to the types of values associated with the model number, a true/false value for the “lockable” attribute, the number of monitors supported (1-4), the number of DisplayPort inputs (0-4), and the number of HDMI inputs (0-4).

Keyboard 204 includes component attributes such as a model number, a language layout, and a connection type. Rules associated with the component attributes may include a limited set of valid model numbers, language layouts, or connection types.

Mouse 206 includes component attributes such as a model number, an “ergonomic” attribute (e.g., indicating if mouse 206 is ergonomically designed), and a connection type. Rules associated with the component attributes may include a limited set of valid model numbers, a true/false value for the “ergonomic” attribute, or a limited set of connection types.

Monitor 210 includes component attributes such as a model number, a size, a resolution, a weight, and a connection type. Rules associated with the component attributes may include a limited set of valid model numbers, a limited number of sizes (e.g., 21″, 24″, 30″), a limited number of resolutions (e.g., 1080p, 4 k, 8 k), a range of valid weights (e.g., 0-40 pounds), or a limited set of connection types (e.g., DisplayPort or HDMI).

Monitor stand 212 includes component attributes such as a model number, a weight supported by monitor stand 212, and an “include base” attribute (e.g., indicating if a base is to be included or not with monitor stand 212). Rules associated with the component attributes may include a limited set of valid model numbers, a range of supported weights (e.g., 0-45 pounds), or a true/false value for the “include base” attribute.

The example configuration of FIG. 2 additionally includes a number of cross-component rules that are applied to attributes of certain components or systems based on other attributes of other components or systems. A first cross-component rule sets the number of system configurations for monitor assembly 208 within the system configuration for computer workstation 200 to be equal to the “number of monitors supported” component attribute of dock 202. A second cross-component rule verifies that the “number of DisplayPort inputs” component attribute of dock 202 is greater than or equal to the number of DisplayPort connection types in all component configurations of monitor 210 within all system configurations of monitor assembly 208. A third cross-component rule verifies that the “number of HDMI inputs” component attribute of dock 202 is greater than or equal to the number of HDMI connection types in all component configurations of monitor 210 within all system configurations of monitor assembly 208. A fourth cross-component rule verifies that the “weight supported” component attribute of monitor stand 212 in a given monitor assembly 208 is greater than or equal to the “weight” attribute of the corresponding monitor 210. A fifth cross-component rule selects HDMI cable 216 or DisplayPort cable 218 for inclusion in monitor assembly 208 based on the value of the “connection type” component attribute of monitor 210 in the same monitor assembly 208.

In turn, the rules may be applied to attribute values of the component attributes to produce valid configurations for computer workstation 200, one or more instances of monitor assembly 208 in computer workstation 200, and components within computer workstation 200 and monitor assembly 208. For example, a configuration for dock 202 in computer workstation 200 may include a value of “3” for the number of monitors supported, a value of “2” for the number of DisplayPort inputs, and a value of “2” for the number of HDMI inputs. As a result, the system configuration for computer workstation 200 may include three configurations for monitor assembly 208.

Continuing with the above example, each configuration for monitor assembly 208 may have “DisplayPort” as an option for the connection type component attribute of monitor 210 if the number of DisplayPort inputs specified in dock 202 is greater than the existing number of DisplayPort connection types specified in all monitor 210 configurations for all instances of monitor assembly 208. Similarly, the connection type component attribute of monitor 210 may have “HDMI” as an option if the number of HDMI inputs specified in dock 202 is greater than the existing number of HDMI connection types specified in all monitor 210 configurations for all instances of monitor assembly 208. When HDMI is selected as the connection type for monitor 210, HDMI cable 216 may be added to the corresponding monitor assembly 208. When DisplayPort is selected as the connection type for monitor 210, DisplayPort cable 218 may be added to the corresponding monitor assembly 208.

Two out of three configurations for monitor assembly 208 may have a weight attribute of “15” for monitor 210 and a weight supported attribute of “20” in monitor stand 212. A third configuration for monitor assembly 208 may have a weight attribute of “25” for monitor 210 and a weight supported attribute of “30” in monitor stand 212. Because the weight supported by each monitor stand 212 is greater than the corresponding monitor 210 weight, values for monitor weights and weights supported by the corresponding monitor stands may be valid.

4. Flexible Cross-Component Configurations in CPQ Platforms

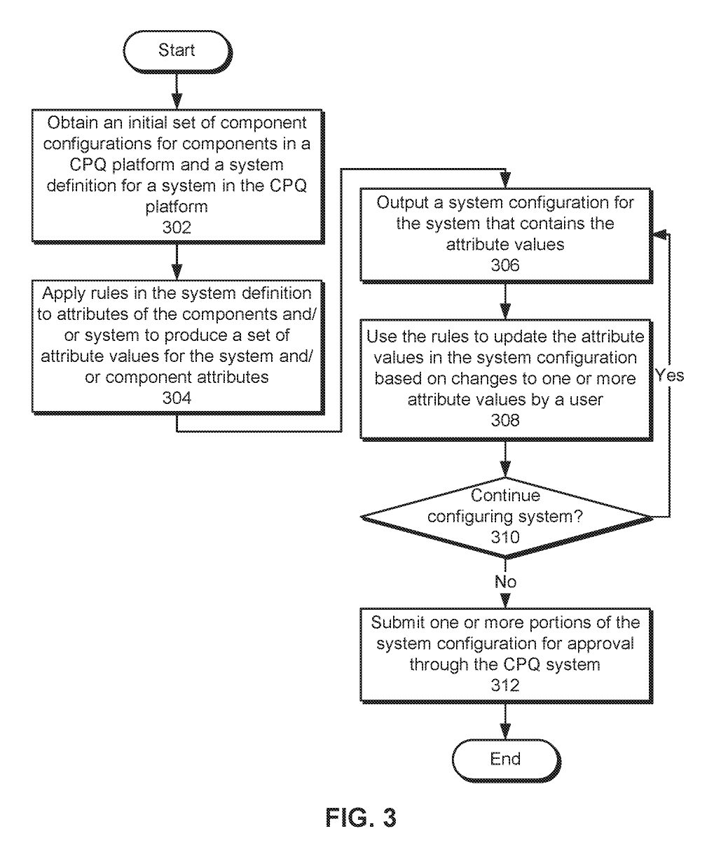

FIG. 3 illustrates a flowchart of operating a configure, price, quote (CPQ) platform in accordance with one or more embodiments. In one or more embodiments, one or more of the steps may be omitted, repeated, or performed in a different order. Accordingly, the specific arrangement of steps shown in FIG. 3 should not be construed as limiting the scope of the embodiments.

First, an initial set of component configurations for components in a CPQ platform and a system definition for a system in the CPQ platform are obtained (operation 302). The component configurations may include a set of component attributes for the components and attribute values for some or all of the component attributes. The attribute values may be pre-specified (e.g., for non-configurable components or component attributes with hardcoded values) or obtained from a user of the CPQ platform (e.g., a sales representative). The system definition may include one or more system attributes of the system, the components, and a set of rules to be applied to the system attributes or component attributes. The system definition may also include one or more additional systems. For example, multiple system definitions may be nested within or reference one another to define a hierarchy of nested or interrelated systems or components within a top-level or “root” system.

Next, rules in the system definition are applied to attributes of the components or system to produce an updated set of attribute values (operation 304) for the system or component attributes. For example, a rule may be used to update or verify a system attribute based on one or more component attributes of the components in the system. As a result, the rule may be applied to input attribute values of the component attribute(s) to calculate or verify an output attribute value for the system attribute. In another example, a rule may be applied to an input attribute value for a first component attribute of a first component to produce an output attribute value for a second component attribute of a second component.

A system configuration for the system that contains the attribute values is then outputted (operation 306). For example, attribute values calculated or updated in operation 204 may be stored in one or more database tables or other data structures representing the system or component configurations. In another example, the attribute values may be displayed with other data related to the system configuration (e.g., component names, attribute names, prices, etc.) within a user interface, such as definition interface 104 of FIG. 1. In a third example, the system configuration may be exported in one or more files, spreadsheets, documents, or other formats.

The rules are also used to update the attribute values in the system configuration based on changes to one or more attribute values by a user (operation 308). For example, the user may change one or more system or component attribute values to conform to constraints or resolve conflicts associated with the rules or accommodate a customer's preferences. In turn, the rules may be applied to the changed attribute values to update additional system or component attribute values in the system configuration.

Configuration of the system may continue (operation 310). During configuration of the system, the system configuration is outputted (operation 306), and the rules are used to update the system or component attribute values based on changes to other attribute values (operation 308). Operations 306-310 may be repeated to reflect iterative changes to the attribute values by the user.

After the user has finished modifying attribute values in the system, one or more portions of the system configuration are submitted for approval through the CPQ system (operation 312). For example, the portion(s) may be used to generate quotes for the corresponding component(s) or the system, and the quotes may be transmitted to a customer, manager, or other entity for approval by the entity. The portion(s) may also, or instead, be sent to external approval applications that are separate from the CPQ system for other types of verification or approval related to the corresponding component(s) or system.

5. Computer Networks and Cloud Networks

In one or more embodiments, a computer network provides connectivity among a set of nodes. The nodes may be local to or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application-programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

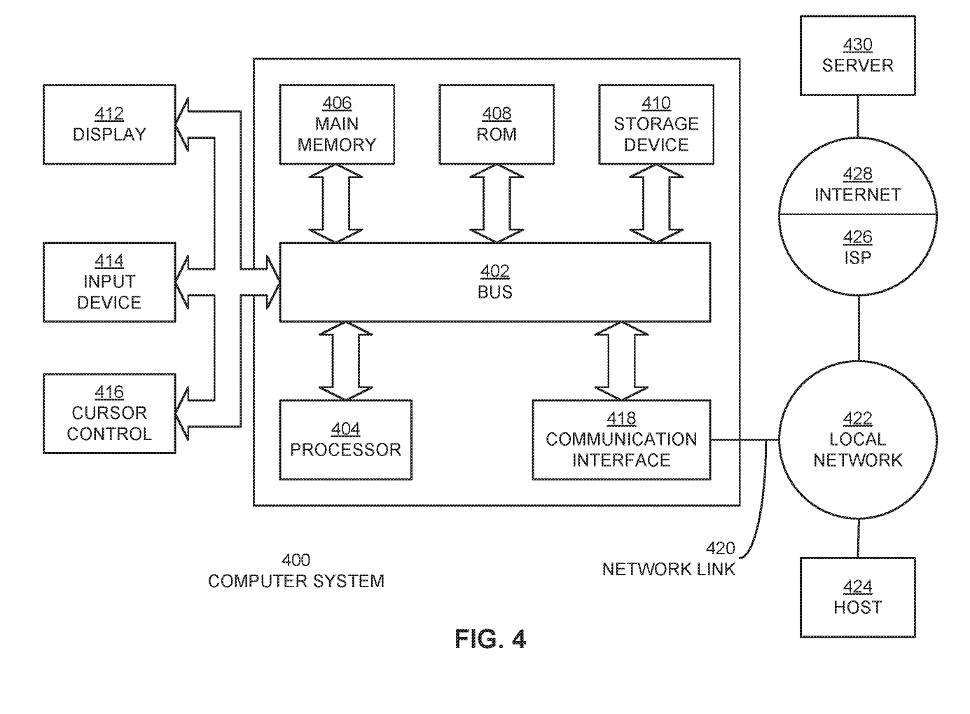

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, optical tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
obtaining a set of component configurations for a first set of components in a configure, price, quote (CPQ) platform, wherein the set of component configurations comprises:
a first set of component attributes for the first set of components; and
a first set of attribute values for the first set of component attributes;
obtaining a first system definition for a first system in the CPQ platform, wherein the first system definition comprises:
a system attribute of the first system;
the first set of components; and
a first set of rules to be applied to the first set of component attributes and the system attribute;
applying, by a computer system, the first set of rules to the first set of attribute values to produce a second set of attribute values for the system attribute and the first set of component attributes; and
outputting, by the computer system, a first system configuration for the first system, wherein the first system configuration comprises the second set of attribute values.

2. The medium of claim 1, wherein the operations further comprise:
obtaining a second system definition for a second system, wherein the second system definition comprises:
the first system;
a second set of components in the CPQ platform; and
a second set of rules to be applied to a second of component attributes of the second set of components;
applying the second set of rules to a third set of attribute values for the second set of component attributes to produce a fourth set of attribute values for the second set of component attributes; and
including the fourth set of attributes in a second system configuration for the second system.

3. The medium of claim 1, wherein the operations further comprise:
using the first set of rules to update, in the first system configuration, the second set of attribute values based on changes to one or more attribute values for the first set of component attributes by a user.

4. The medium of claim 1, wherein applying the first set of rules to the first set of attribute values to produce the second set of attribute values for the first set of attributes comprises:
applying a rule to input attribute values of one or more component attributes in the first set of component attributes to obtain an output attribute value for the system attribute; and
including the output attribute value in the second set of attribute values.

5. The medium of claim 1, wherein applying the first set of rules to the first set of attribute values to produce the second set of attribute values for the first set of attributes comprises:
applying a rule to an input attribute value for a first component attribute of a first component to obtain an output attribute value for a second component attribute of a second component; and
including the output attribute value in the second set of attribute values.

6. The medium of claim 1, wherein the operations further comprise:
submitting one or more portions of the first system configuration for approval through the CPQ platform.

7. The medium of claim 1, wherein the first set of rules comprises a condition to be applied to an attribute.

8. The medium of claim 1, wherein the first set of rules comprises a constraint on an attribute.

9. The medium of claim 1, wherein the first set of rules comprises a rule for hiding an attribute.

10. The medium of claim 1, wherein the first set of rules comprises a rule for setting a price.

11. The medium of claim 1, wherein the first set of rules comprises a rule for recommending a component.

12. The medium of claim 1, wherein the first set of rules comprises a configuration flow for configuring the second set of attributes.

13. A method, comprising:
obtaining a set of component configurations for a first set of components in a configure, price, quote (CPQ) platform, wherein the set of component configurations comprises:
a first set of component attributes for the first set of components; and
a first set of attribute values for the first set of component attributes;
obtaining a first system definition for a first system in the CPQ platform, wherein the first system definition comprises:
a system attribute of the first system;
the first set of components; and
a first set of rules to be applied to the first set of component attributes and the system attribute;
applying the first set of rules to the first set of attribute values to produce a second set of attribute values for the system attribute and the first set of component attributes; and
outputting a first system configuration for the first system, wherein the first system configuration comprises the second set of attribute values.

14. The method of claim 13, further comprising:
obtaining a second system definition for a second system, wherein the second system definition comprises:
the first system;
a second set of components in the CPQ platform; and
a second set of rules to be applied to a second of component attributes of the second set of components;
applying the second set of rules to a third set of attribute values for the second set of component attributes to produce a fourth set of attribute values for the second set of component attributes; and
including the fourth set of attributes in a second system configuration for the second system.

15. The method of claim 13, further comprising:
using the first set of rules to update, in the first system configuration, the second set of attribute values based on changes to one or more attribute values for the first set of component attributes by a user.

16. The method of claim 13, wherein applying the first set of rules to the first set of attribute values to produce the second set of attribute values for the first set of attributes comprises:
applying a rule to input attribute values of one or more component attributes in the first set of component attributes to obtain an output attribute value for the system attribute; and
including the output attribute value in the second set of attribute values.

17. The method of claim 13, wherein applying the first set of rules to the first set of attribute values to produce the second set of attribute values for the first set of attributes comprises:
applying a rule to an input attribute value for a first component attribute of a first component to obtain an output attribute value for a second component attribute of a second component; and
including the output attribute value in the second set of attribute values.

18. The method of claim 13, further comprising:
submitting one or more portions of the first system configuration for approval through the CPQ platform.

19. The method of claim 13, wherein the first set of rules comprises at least one of:
a condition to be applied to an attribute;
a constraint on the attribute;
a rule for hiding the attribute;
a rule for setting a price;
a rule for recommending a component; and
a configuration flow for configuring the second set of attributes.

20. An apparatus, comprising:
one or more processors; and
memory storing instructions that, when executed by the one or more processors, cause the apparatus to:
obtain a set of component configurations for a first set of components in a configure, price, quote (CPQ) platform, wherein the set of component configurations comprises:
a first set of component attributes for the first set of components; and
a first set of attribute values for the first set of component attributes;
obtain a first system definition for a first system in the CPQ platform, wherein the first system definition comprises:
a system attribute of the first system;
the first set of components; and
a first set of rules to be applied to the first set of component attributes and the system attribute;
apply the first set of rules to the first set of attribute values to produce a second set of attribute values for the system attribute and the first set of component attributes; and
output a first system configuration for the first system, wherein the first system configuration comprises the second set of attribute values.
